(19) United States
(12) Patent Application Publication
(10) Pub. No.: US 2017/0088134 A1
(43) Pub. Date: Mar. 30, 2017

(54) CONTROL METHOD AND CONTROL APPARATUS FOR A BALANCE CAR AND STORAGE MEDIUM

(71) Applicant: Xiaomi Inc., Beijing (CN)

(72) Inventors: Huayijun LIU, Beijing (CN); Mingyong TANG, Beijing (CN); Tao CHEN, Beijing (CN)

(73) Assignee: Xiaomi Inc.

(21) Appl. No.: 15/277,712

(22) Filed: Sep. 27, 2016

(30) Foreign Application Priority Data
Sep. 28, 2015 (CN) 201510627152.9

(51) Int. Cl. B60W 30/095; G08G 1/16; G05D 1/02

(52) U.S. Cl. CPC B60W 30/0956; G05D 1/0238; G08G 1/165; B60W 2550/10; B60W 2720/106; B62K 11/007

(57) ABSTRACT

A method for controlling a balance car is provided. The method includes: identifying an obstacle; identifying a type of the obstacle in front of the balance car, the type of the obstacle including an impassable obstacle type; and when the type of the obstacle is the impassable obstacle type, controlling the balance car to decelerate.

This application is based upon and claims priority to Chinese Patent Application No. 201510627152.9, filed Sep. 28, 2015, the entire contents of which are incorporated herein by reference.

### TECHNICAL FIELD

The present disclosure generally relates to the field of automatic control, and, more particularly, to a method and apparatus for controlling a balance car, and a storage medium.

### BACKGROUND

A balance car is also known as an electric balance car and is a new kind of short-distance transportation instrument.

The balance car is driven by an internal driving motor to go forward and backward. If there is an obstacle in front of the balance car, the driver may fall over.

### SUMMARY

According to a first aspect of the present disclosure, there is provided a method for controlling a balance car, comprising: identifying an obstacle; identifying a type of the obstacle in front of the balance car, the type of the obstacle including an impassable obstacle type; and when the type of the obstacle is the impassable obstacle type, controlling the balance car to decelerate.

According to a second aspect of the present disclosure, there is provided a balance car, comprising: a control chip; a storage for storing instructions executable by the control chip; wherein, the control chip is configured to: identify an obstacle; identify a type of the obstacle in front of the balance car, the type of the obstacle including an impassable obstacle type; and when the type of the obstacle is the impassable obstacle type, control the balance car to decelerate.

According to a third aspect of the present disclosure, there is provided a non-transitory computer-readable storage medium having stored therein instructions that, when executed by a processor of a device, causes the device to perform a method for controlling a balance car, the method comprising: identifying an obstacle; identifying a type of the obstacle in front of the balance car, the type of the obstacle including an impassable obstacle type; if the type of the obstacle is the impassable obstacle type, controlling the balance car to decelerate.

### BRIEF DESCRIPTION OF THE DRAWINGS

The accompanying drawings, which are incorporated in and constitute a part of this specification, illustrate embodiments consistent with the invention and, together with the description, serve to explain, rather than limit, the principles of the present disclosure.

FIG. 1 is a schematic diagram of a balance car according to an exemplary embodiment.

FIG. 2 is a flowchart of a method for controlling a balance car according to an exemplary embodiment.

FIG. 3 is a flowchart of a method for controlling a balance car according to another exemplary embodiment.

FIG. 4A is a diagram of a distance measuring component for identifying an obstacle according to an exemplary embodiment.

FIG. 4B is a diagram of an implementation for determining whether there is an alternate route in front of a balance car according to an exemplary embodiment.

FIG. 5 is a flowchart of a method for controlling a balance car according to another exemplary embodiment.

FIG. 6 is a diagram of an implementation for identifying an obstacle in an image frame according to an exemplary embodiment.

FIG. 7 is a block diagram of a control apparatus for a balance car according to an exemplary embodiment.

FIG. 8 is a block diagram of a control apparatus for a balance car according to another exemplary embodiment.

FIG. 9 is a block diagram of a balance car according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

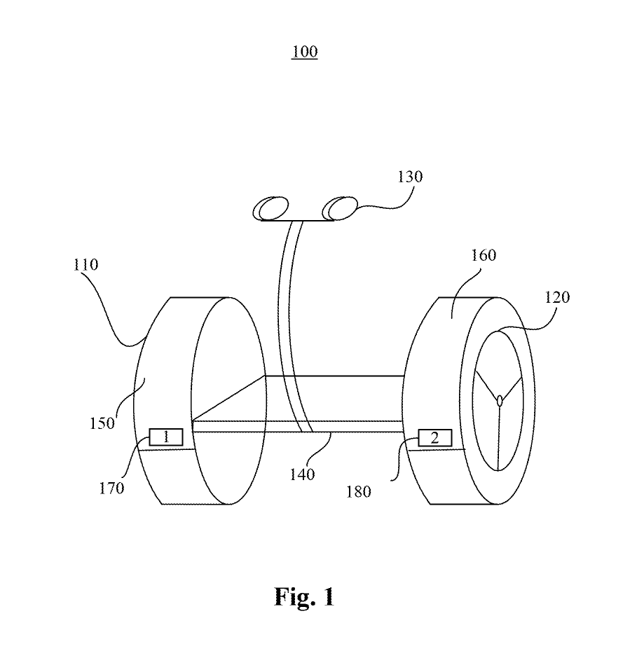

FIG. 1 is a schematic diagram of a balance car 100 according to an exemplary embodiment of the present disclosure. Referring to FIG. 1, balance car 100 includes two parallel wheels 110 and 120, wheel housings 150 and 160, a turning control component 130, a load bearing pedal 140, and obstacle identifying components 170 and 180.

Turning control component 130 is connected to load bearing pedal 140, and used to control turning of balance car 100. Turning control component 130 is implemented through manual control or leg control. However, implementation of turning control is not so limited.

Obstacle identifying components 170 and 180 are used to identify an obstacle in a heading direction of balance car 100. Obstacle identifying components 170 and 180 can be any distance measuring components capable of identifying the size and distance of an object, such as infrared ray sensing apparatus, ultrasonic wave sensing apparatus, or laser range finder, etc. Obstacle identifying components 170 and 180 can also be any image acquiring components capable of capturing images, such as a camera.

In FIG. 1, obstacle identifying component 170 is provided as an example at position 1 of wheel housing 150, and obstacle identifying component 180 is also provided as an example at position 2 of wheel housing 160. Obstacle identifying components 170 and 180 can also be provided at any positions on balance car 100 deemed feasible by a person skilled in the art, such as a position where load bearing pedal 140 is engaged with turning control component 130, a position for detecting a front left oblique direction of the left wheel, or a position for detecting a front right oblique direction of the right wheel, etc. Additionally, the number of obstacle identifying components 170 and 180 is provided as two as an example in this embodiment. However, the number of the obstacle identifying components is at least one. The number of the obstacle identifying components is not limited in this embodiment. Obstacle identifying components 170 and 180 also have an ability to move in a vertical direction. Alternatively, obstacle identifying components 170 and 180 have an ability to rotate in four directions, such as, up, down, left, and right.

Additionally or alternatively, balance car 100 includes other components, such as a control chip, a storage, and a driving motor, etc. (not shown in the figures). The control chip is connected to the driving motor, turning control component 130, and obstacle identifying components 170 and 180. Further, the control chip controls balance car 100 to move forward, move backward, stop, and turn according to executable instructions stored in the storage.

Balance car 100 is an exemplary implementation of a method for controlling a balance car provided in the embodiments of the present disclosure. The method for controlling a balance car of the present disclosure can be used not only in a two-wheel balance car, but also in other balance cars identical or similar to the two-wheel balance car, such as a single-wheel balance car. The embodiments of the present disclosure are not limited to the implementation of the control method in balance car 100.

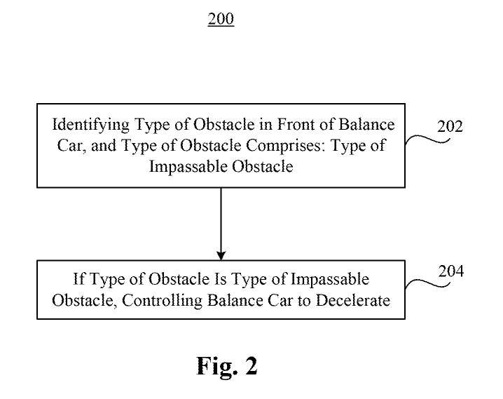

FIG. 2 is a flowchart of a method 200 for controlling a balance car according to an exemplary embodiment. Referring to FIG. 2, method 200 is used in balance car 100 of FIG. 1, and includes step 202 and step 204.

In step 202, a type of an obstacle in front of the balance car is identified. The type of the obstacle includes an impassable obstacle type. Alternatively, the control chip identifies the type of the obstacle in front of any wheel by utilizing an obstacle identifying component. Alternatively, the obstacle identifying component includes a distance measuring component and/or an image acquiring component. In step 204, if the type of the obstacle is the impassable obstacle type, the balance car is controlled to decelerate.

The method for controlling a balance car provided in this embodiment identifies the type of the obstacle in front of the balance car, and controls the balance car to decelerate if the type of the obstacle is the impassable obstacle type, thereby solves the problem that the driver is likely to fall over when there is an impassable obstacle in front of the balance car, and achieves the effects that the balance car automatically identifies the obstacle, and prevents tumbles caused by collision with the obstacle when the obstacle is an impassable obstacle.

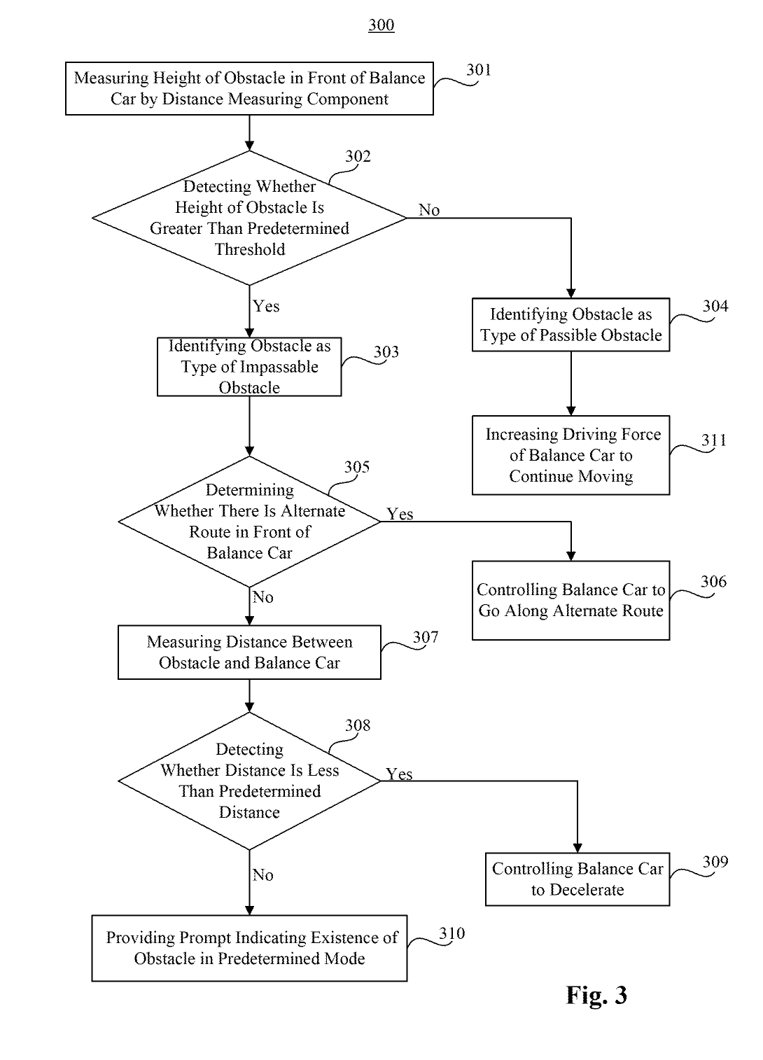

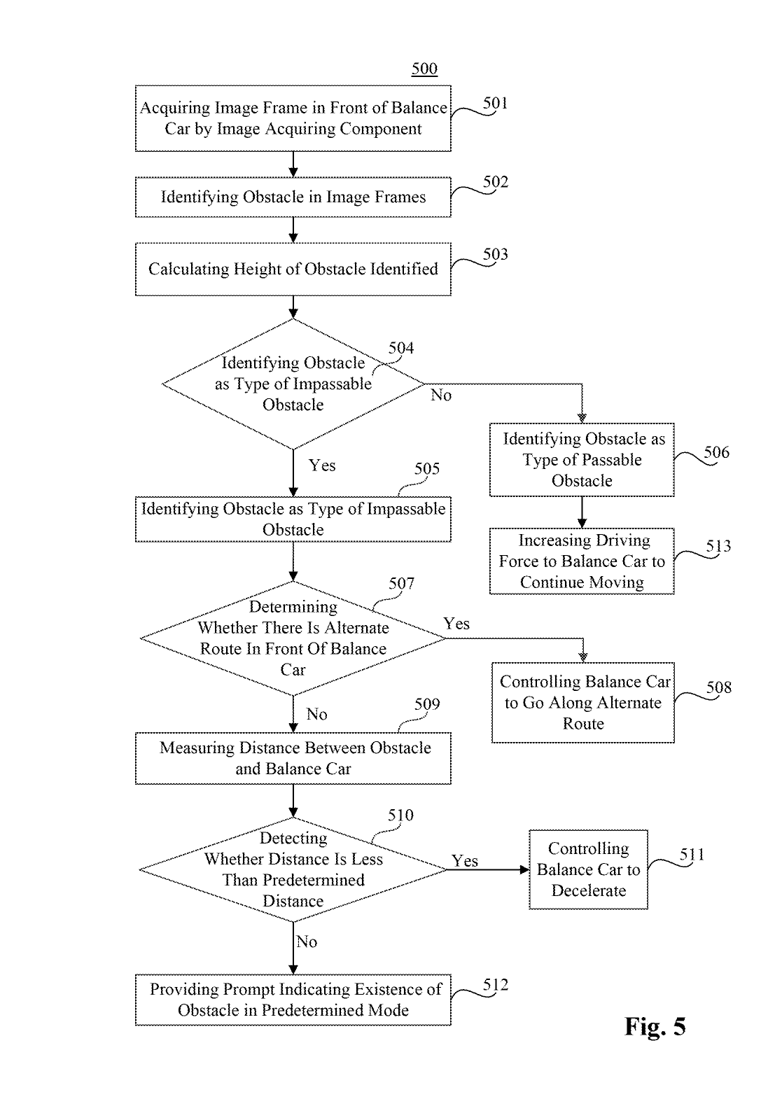

Alternatively, methods of identifying the type of the obstacle in front of the balance car in step 202 include the following two methods. The first method includes identifying the type of the obstacle by utilizing the distance measuring component, which is described with reference to FIG. 3 below. The second method includes identifying the type of the obstacle by utilizing the image acquiring component, which is described with reference to FIG. 5 below.

FIG. 3 is a flowchart of a method 300 for controlling a balance car according to an exemplary embodiment. Referring to FIG. 3, this embodiment illustrates method 300 implemented in balance car 100 of FIG. 1. Control method 300 for a balance car includes the following steps.

In step 301, a height of the obstacle in front of the balance car is measured by utilizing a distance measuring component. The control chip of the balance car controls the distance measuring component to transmit a detection signal at predetermined intervals. The detection signal is a laser, infrared ray, or ultrasonic wave, etc. A reflected signal will be returned when the detection signal encounters an obstacle. Thus, when the distance measuring component receives the reflected signal, this indicates that there is an obstacle in front of the car. In general, the height of the obstacle is not lower than the height at which the distance measuring component is positioned.

For example, the distance measuring component mounted on the housing of the balance car is located at a position 5 cm above the ground. If a reflected signal of a detection signal is received, it indicates that there is an obstacle having a height of at least 5 cm in front of the balance car. If the reflected signal is not received, it indicates that there is no obstacle having a height over 5 cm in front of the balance car.

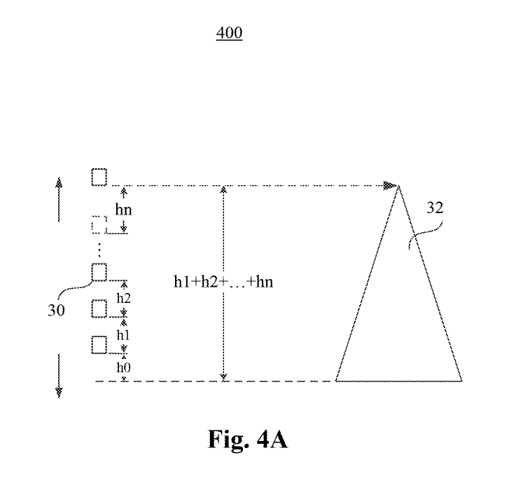

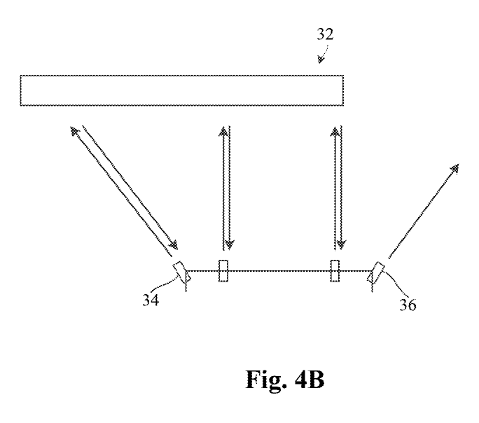

Alternatively, referring to FIG. 4A, a distance measuring component 30 is capable of moving up and down in a vertical direction on the balance car. Distance measuring component 30 transmits a detection signal at different positions in the vertical direction. Alternatively, distance measuring component 30 transmits a detection signal at a height of h0 from the ground, elevates height by h1 and transmits another detection signal after it receives a reflected signal, and elevates height by h2 and transmits yet another detection signal after it receives a reflected signal. The process repeats. When distance measuring component 30 does not receive a reflected signal, a top of the obstacle 32 is detected, and the height of the obstacle measured is h1+h2+ . . . +hn.

Implementation of measuring a height of an obstacle by utilizing a distance measuring component is not limited. For example, a balance car may be provided with a plurality of distance measuring components at different positions thereof to measure the height of the obstacle based on whether each of the plurality of distance measuring components has received a reflected signal of a detection signal.

In step 302, whether the height of the obstacle is greater than a predetermined threshold is detected. Alternatively, the predetermined threshold is the maximum height of the obstacle that can be passed by the balance car. Alternatively, the predetermined threshold is 1/x of the height of the tire of the balance car or other numerical values, which are limited in this embodiment. If the height of the obstacle is greater than the predetermined threshold, step 303 is executed. If the height of the obstacle is less than the predetermined threshold, step 304 is executed.

In step 303, if the height of the obstacle is greater than the predetermined threshold, the obstacle is identified as an impassable obstacle type. When the obstacle is the impassable obstacle type, step 305 is executed. In step 304, if the height of the obstacle is not greater than the predetermined threshold, the obstacle is identified as a passable obstacle type. When the obstacle is the passable obstacle type, step 311 is executed. In step 305, whether there is an alternate route in front of the balance car is determined. Step 305 includes two alternative methods. The first method includes: whether there is an alternate route at the left or right side of the advancing direction is determined by utilizing a distance measuring component provided in the front left oblique direction or front right oblique direction of the balance car. The second method includes: whether there is an alternate route at the left or right side of the advancing direction is determined by utilizing a distance measuring component capable of rotating in a horizontal direction.

As an alternative to the first method, the front left oblique direction is a direction that forms a first included angle from the forward direction to the left, and the front right oblique direction is a direction that forms a second included angle from the forward direction to the right. The distance measuring component determines whether there is an obstacle in the front left oblique direction or the front right oblique direction. If there is no obstacle, there is an alternate route.

For example, as shown in FIG. 4B, the balance car is provided with a distance measuring component 34 for detecting the front left oblique direction of the left wheel and a distance measuring component 36 for detecting a front right oblique direction of the right wheel. If the distance measuring component for detecting the forward direction receives a reflected signal of a detection signal, and distance measuring component 34 also receives a reflected signal of the detection signal, but distance measuring component 36 does not receive a reflected signal, it indicates that there is an alternate route in the front right direction.

Similarly, if the distance measuring component for detecting the forward direction receives a reflected signal of a detection signal, and distance measuring component 36 also receives a reflected signal of the detection signal, but distance measuring component 34 does not receive a reflected signal, it indicates that there is an alternate route in the front left direction.

Regarding the second method, the distance measuring component is capable of turning to the left or turning to the right. The distance measuring component determines whether there is an obstacle in the front left oblique direction or in the front right oblique direction. If there is no obstacle, there is an alternate route. If there is an alternate route, step 306 is executed. If there is no alternate route, step 307 is executed. In step 306, if there is an alternate route in front of the balance car, the balance car is controlled to go along the alternate route. If there is an alternate route in front of the balance car, the control chip controls the balance car to go along the alternate route. In step 307, the distance between the obstacle and the balance car is measured. Alternatively, the control chip measures the distance between the obstacle in front of any wheel and the balance car by utilizing the distance measuring component. For example, the control chip acquires the distance by a calculation based on the transmission time of the detection signal and the reception time of the reflected signal, and in combination with the traveling speed of the balance car.

In step 308, whether the distance is less than a predetermined distance is detected. The control chip detects whether the distance between the obstacle and the balance car is less than the predetermined distance. Alternatively, the predetermined distance is a maximum distance needed when the balance car turns. The predetermined distance may be a multiple of the diameter of the tire or other numerical values, which is not limited in this embodiment. Alternatively, the predetermined distance is in positive proportion to the current speed of the balance car. The faster the current speed is, the larger is the predetermined distance. The slower the current speed is, the smaller is the predetermined distance.

If the distance is less than the predetermined distance, step 309 is executed. If the distance is greater than the predetermined distance, step 310 is executed. In step 309, if the distance is less than the predetermined distance, the balance car is controlled to decelerate, and a prompt indicating an existence of the obstacle is provided in a predetermined mode. If the distance is less than the predetermined distance, the control chip controls the balance car to stop by deceleration. In general, the control chip controls the balance car to decelerate and stop before the obstacle; but a situation where the balance car collides with the obstacle before it completely stops during the deceleration is also possible to occur.

Alternatively, the control chip provides a prompt indicating an existence of the obstacle in a predetermined mode, wherein the predetermined mode includes at least one of playing a prompt tone, vibrating a predetermine part of the balance car, or flickering a signal light. For example, when an impassable obstacle in front of the balance car is identified, and when the distance between the impassable obstacle and the balance car reaches the predetermined distance, the balance car will produce a beep tone.

In step 310, if the distance is less than the predetermined distance, the balance car is controlled to continue moving. In step 311, if the type of the obstacle is the passable obstacle type, a driving force of the balance car is increased to continue moving. If the type of the obstacle is the passable obstacle type, the control chip controls the driving motor to increase a driving force of the balance car to move on. The order of the steps 305, 307 and 310 is not limited to the above sequence.

The control method for a balance car provided in this embodiment identifies the type of the obstacle in front of the balance car, and controls the balance car to decelerate if the type of the obstacle is the impassable obstacle type, thereby solves the problem that a driver is likely to fall over once there is an impassable obstacle in front of the balance car, and achieves the effect that the balance car automatically identifies the obstacle and prevents tumbling caused by collision with the obstacle when the obstacle is an impassable obstacle.

The method for controlling a balance car provided in this embodiment measures the height and distance of the obstacle by utilizing the distance measuring component, thereby enables the balance car to identify the type of the obstacle and decelerate to avoid the obstacle based on the distance between the obstacle and the balance car. Further, the method for controlling the balance car provided in this embodiment determines whether there is an alternate route in front of the balance car, and automatically controls the balance car to go along the alternate route if there is an alternate route, thereby achieving the effect of preventing collision between the balance car and the obstacle without affecting the normal travel of the balance car.

FIG. 5 is a flowchart of a method 500 for controlling a balance car according to another exemplary embodiment. Referring to FIG. 5, the present embodiment is based on the embodiment illustrated in FIG. 1, and method 500 comprises the following steps.

In step 501, an image frame in front of the balance car is acquired by an image acquiring component. The image acquiring component may be mounted on each of the two wheel housings of the balance car, or mounted on a part connecting the load bearing pedal and the turning control component. The control chip controls the image acquiring component to acquire images in front of the balance car to form continuous image frames.

In step 502, an obstacle in the image frames is identified. Since color differences between the ground and other objects on the ground are obvious, the ground and other objects in the image frames can be differentiated and determined based on pixel variations in the image frames.

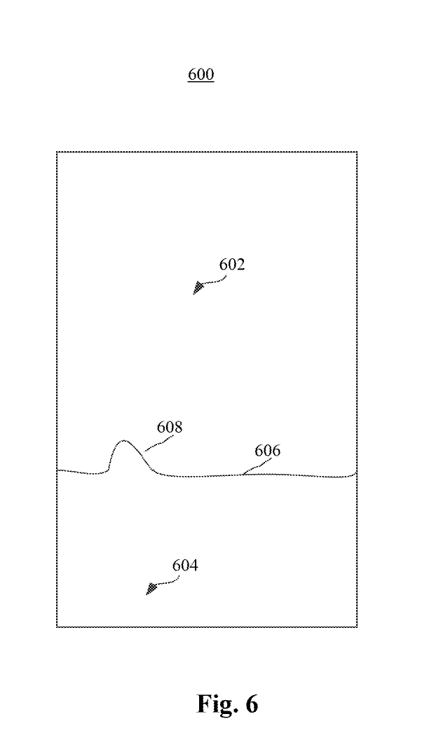

Alternatively, FIG. 6 is an image frame 600 acquired by the image acquiring component. After the control chip obtains image frame 600 acquired by the image acquiring component, a first region 602 and a second region 604 are obtained from a binary process of image frame 600 based on the color differences in image frame 600, wherein a road line 606 is formed at an intersection of first region 602 and second region 604. The control chip detects whether road line 606 has a protrusion 608. If road line 606 has protrusion 608, the control chip identifies protrusion 608 as an obstacle.

In step 503, a height of the obstacle identified is calculated. In a first exemplary embodiment, the control chip calculates the height of the obstacle according to the height of the obstacle in the image frame and a predetermined measuring scale. For example, if the predetermined measuring scale is 1:3, when the height of the obstacle in the image frame is 1 cm, the height of the obstacle calculated is 3 cm. When the obstacle is closer to the balance car, the height of the obstacle calculated is also closer.

In a second exemplary embodiment, the balance car is provided with a distance measuring component. The distance measuring component can measure a distance from the obstacle to the balance car. The control chip first searches for a measuring scale corresponding to the distance, and then calculates the height of the obstacle according to the height of the obstacle in the image frame and the measuring scale corresponding to the distance. For example, if the measuring scale corresponding to the distance is 1:5, when the height of the obstacle in the image frame is 1 cm, the height of the obstacle calculated is 5 cm.

In a third exemplary embodiment, there are two image acquiring components, and the control chip can calculate an actual height of the obstacle, according to the binocular imaging principle, based on the protrusion (i.e., the obstacle) in two image frames acquired by the two image acquiring components. The present embodiment does not limit the way by which the control chip calculates the height of the obstacle.

In step 504, whether the height of the obstacle is greater than a predetermined threshold is detected. The control chip detects whether the height of the obstacle calculated is greater than the predetermined threshold. Alternatively, the predetermined threshold is the maximum height of the obstacle that can be passed by the balance car.

If the height of the obstacle is greater than the predetermined threshold, step 505 is executed. If the height of the obstacle is less than the predetermined threshold, step 506 is executed. In step 505, if the height of the obstacle is greater than the predetermined threshold, the obstacle is identified as a type of impassable obstacle. When the obstacle is the impassable obstacle type, step 507 is executed. In step 506, if the height of the obstacle is less than the predetermined threshold, the obstacle is identified as the passable obstacle type. When the obstacle is the passable obstacle type, step 513 is executed.

In step 507, when the obstacle is the impassable type, whether there is an alternate route in front of the balance car is determined. This step includes the following three methods:

1. Determining whether there is an alternate route at the left side or the right side of the heading direction through the image frames acquired by the image acquiring component. By a process similar to step 501, the control chip determines whether there is an obstacle in the front left oblique direction or the front right oblique direction through the image frames acquired by the image acquiring component. If there is no obstacle, there is an alternate route. Alternatively, the front left oblique direction is a direction that forms a first included angle from the forward direction to the left. The front right oblique direction is a direction that forms a second included angle from the forward direction to the right.

2. Whether there is an alternate route at the left side or the right side of the advancing direction is determined by utilizing a distance measuring component provided in the front left oblique direction or the front right oblique direction of the balance car. The control chip determines whether there is any obstacle in the front left oblique direction or the front right oblique direction by utilizing the distance measuring component. If there is no obstacle, there is an alternate route.

3. Whether there is an alternate route at the left side or the right side in the heading direction is determined by utilizing a distance measuring component capable of rotating in a horizontal direction.

The distance measuring component is capable of turning to the left or turning to the right. Then, the control chip determines whether there is an obstacle in the front left oblique direction or the front right oblique direction by using the distance measuring component. If there is no obstacle, there is an alternate route.

If there is an alternate route, step 508 is executed. If there is no alternate route, step 509 is executed. In step 508, if there is an alternate route in front of the balance car, the balance car is controlled to go along the alternate route. If there is an alternate route in front of the balance car, the control chip controls the balance car to go along the alternate route.

In step 509, the distance between the obstacle and the balance car is measured. Alternatively, the control chip measures the distance between the obstacle in front of any wheel and the balance car by utilizing the distance measuring component. For example, the control chip acquires the distance by a calculation based on the transmission time of the detection signal, the reception time of the reflected signal, and the traveling speed of the balance car.

In step 510, whether the distance is less than a predetermined distance is detected. The control chip detects whether the distance between the obstacle and the balance car is less than the predetermined distance. Alternatively, the predetermined distance is the maximum distance needed when the balance car turns. Alternatively, the predetermined distance may be a multiple of the diameter of the tire or other numerical values, which are not limited in this embodiment. Alternatively, the predetermined distance is in positive proportion to the current speed of the balance car. The faster the current speed is, the larger is the predetermined distance. The slower the current speed is, the smaller is the predetermined distance.

If the distance is less than the predetermined distance, step 511 is executed. If the distance is greater than the predetermined distance, step 512 is executed. In step 511, if the distance is less than the predetermined distance, the balance car is controlled to decelerate, and a prompt indicating an existence of an obstacle is provided in a predetermined mode.

If the distance is less than the predetermined distance, the control chip controls the balance car to stop by deceleration. In general, the control chip controls the balance car to decelerate and stop before the obstacle; but a situation where the balance car collides with an obstacle before it stops completely during deceleration may occur. Alternatively, the control chip provides a prompt indicating the existence of an obstacle in a predetermined mode, wherein the predetermined mode includes at least one of producing a prompt tone, vibrating a predetermine part of the balance car, or flickering a signal light.

For example, when an impassable obstacle in front of the balance car is identified, and when the impassable obstacle reaches the predetermined distance from the balance car, the balance car will produce a beep prompt tone.

In step 512, if the distance is not less than the predetermined distance, the balance car is controlled to continue moving. In step 513, if the type of obstacle is the passable obstacle type, a driving force of the balance car is increased to continue moving. If the type of the obstacle is the passable obstacle type, the control chip controls a driving motor to increase the driving force of the balance car to move on.

The method for controlling a balance car provided in this embodiment identifies a type of an obstacle in front of the balance car, and controls the balance car to decelerate if the type of the obstacle is the impassable obstacle type, thereby solving the problem that the driver is likely to fall over once there is an impassable obstacle in front of the balance car, and achieves the effect that the balance car can automatically identify the obstacle and try to prevent tumbling caused by collision with the obstacle when the obstacle is an impassable obstacle.

The control method for a balance car provided in this embodiment measures the height and distance of the obstacle by utilizing the image acquiring component, thereby enabling the balance car to identify the type of obstacle and decelerate to avoid the obstacle according to the distance between the obstacle and the balance car.

The control method of the balance car provided in this embodiment also determines whether there is an alternate route in front of the balance car, and automatically controls the balance car to go along the alternate route if there is an alternate route, thereby achieving the effect of preventing collision between the balance car and the obstacle without affecting the normal travel of the balance car.

The following are embodiments directed to apparatus of the present disclosure which are used to execute the methods of the present disclosure. For details of the embodiments directed to apparatus, reference can be made to the embodiments directed to methods.

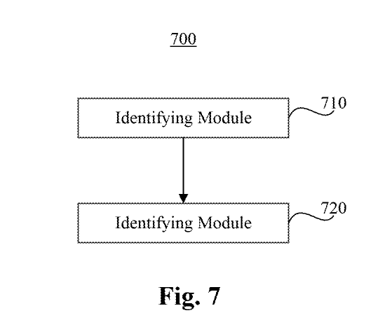

FIG. 7 is a block diagram of an apparatus 700 for controlling a balance car according to an exemplary embodiment. Referring to FIG. 7, apparatus 700 is implemented as an entirety or as a part of the balance car by software, hardware, or a combination thereof. Apparatus 700 includes an identifying module 710 and a control module 720.

Identifying module 710 is configured to identify a type of an obstacle in front of the balance car, and the type may be the impassable obstacle type. Control module 720 is configured to control the balance car to decelerate when the type of obstacle is the impassable obstacle type.

Apparatus 700 for controlling a balance car provided in this embodiment identifies the type of the obstacle in front of the balance car, and controls the balance car to decelerate if the type of the obstacle is the impassable obstacle type, thereby solving the problem that the driver is likely to fall over once there is an impassable obstacle in front of the balance car, and achieves the effect that the balance car can automatically identify the obstacle and try to prevent tumbling caused by collision with the obstacle when the obstacle is an impassable obstacle.

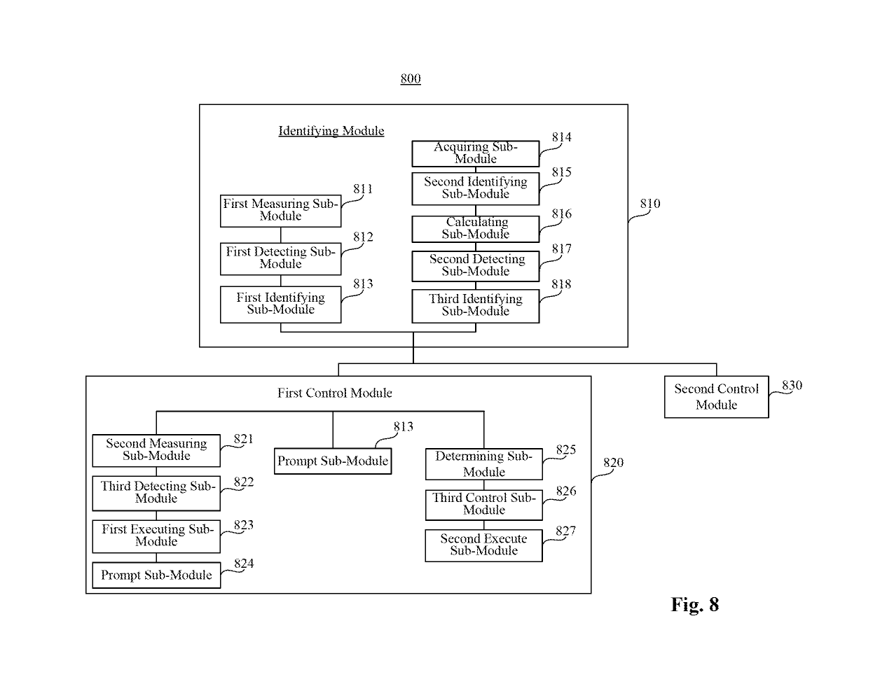

FIG. 8 is a block diagram of an apparatus 800 for controlling a balance car according to an exemplary embodiment. Referring to FIG. 8, apparatus 800 can be implemented as an entirety or as a part of the balance car by software, hardware or a combination thereof. Apparatus 800 includes an identifying module 810 and a first control module 820.

Identifying module 810 is configured to identify a type of an obstacle in front of the balance car, which may be the impassable obstacle type. First control module 820 is configured to control the balance car to decelerate when the type of the obstacle is the impassable obstacle type. Alternatively, a type of an obstacle may be the passable obstacle type. Apparatus 800 further includes a second control module 830. Second control module 830 is configured to increase a driving force of the balance car to continue moving, when the type of the obstacle is a type of passable obstacle. In some embodiments, identifying module 810 includes a first measuring sub-module 811, a first detecting sub-module 812, and a first identifying sub-module 813.

First measuring sub-module 811 is configured to measure a height of the obstacle in front of the balance car by utilizing a distance measuring component. First detecting sub-module 812 is configured to detect whether the height of the obstacle is greater than a predetermined threshold. First identifying sub-module 813 is configured to identify the obstacle as the impassable obstacle type, when the height of the obstacle is greater than the predetermined threshold. In some embodiments, identifying module 810 further includes an acquiring sub-module 814, a second identifying sub-module 815, a calculating sub-module 816, a second detecting sub-module 817, and a third identifying sub-module 818.

Acquiring sub-module 814 is configured to acquire an image frame in front of the balance car by utilizing an image acquiring component. Second identifying sub-module 815 is configured to identify the obstacle in the image frame. Calculating sub-module 816 is configured to calculate the height of the obstacle identified. Second detecting sub-module 817 is configured to detect whether the height of the obstacle is greater than a predetermined threshold. Third identifying sub-module 818 is configured to identify the obstacle as the impassable obstacle type when the height of the obstacle is greater than the predetermined threshold.

In some embodiments, first control module 820 further includes a second measuring sub-module 821, a third detecting sub-module 822, and a first executing sub-module 823. Second measuring sub-module 821 is configured to measure a distance between the obstacle and the balance car. Third detecting sub-module 822 is configured to detect whether the distance is less than a predetermined distance. First executing sub-module 823 is configured to control the balance car to decelerate when the distance is less than the predetermined distance.

In some embodiments, first control module 820 further includes a prompt sub-module 824. Prompt sub-module 824 is configured to provide a prompt indicating the existence of an obstacle in a predetermined mode when the type of the obstacle is the impassable obstacle type, wherein the predetermined mode includes at least one of playing a prompt tone, vibrating a predetermine part of the balance car, or flickering a signal light. In some embodiments, apparatus 800 for a balance car further includes a determining sub-module 825, a third control sub-module 826, and a second executing sub-module 827.

Determining sub-module 825 is configured to determine whether there is an alternate route in front of the balance car when the type of the obstacle is the impassable obstacle type. Third control sub-module 826 is configured to control the balance car to go along the alternate route when the there is an alternate route in front of the balance car. First control module 820 is further configured to control the balance car to decelerate when there is no alternate route in front of the balance car.

Apparatus 800 provided in this embodiment identifies the type of the obstacle in front of the balance car, and controls the balance car to decelerate if the type of the obstacle is the impassable obstacle type, thereby solving the problem that the driver is likely to fall over once there is an impassable obstacle in front of the balance car, and achieves the effect that the balance car can automatically identify the obstacle and try to prevent tumbling caused by collision with the obstacle when the obstacle is an impassable obstacle.

Apparatus 800 for a balance car provided in this embodiment measures the height and distance of the obstacle by utilizing the distance measuring component, thereby enabling the balance car to identify the type of obstacle and to decelerate to avoid the obstacle based on the distance between the obstacle and the balance car.

The control apparatus for a balance car provided in this embodiment determines whether there is an alternate route in front of the balance car, and automatically controls the balance car to go along the alternate route if there is an alternate route, thereby achieving the effect of preventing collision between the balance car and obstacles without affecting the normal travel of the balance car.

An exemplary embodiment of the present disclosure provides a balance car implemented with the control method, and the balance car includes a control chip and a storage for storing instructions executable by the control chip, wherein the control chip is configured to identify a type of an obstacle in front of the balance car. The type of the obstacle may be an impassable obstacle type. When the type of the obstacle is the impassable obstacle type, the control chip controls the balance car to decelerate.

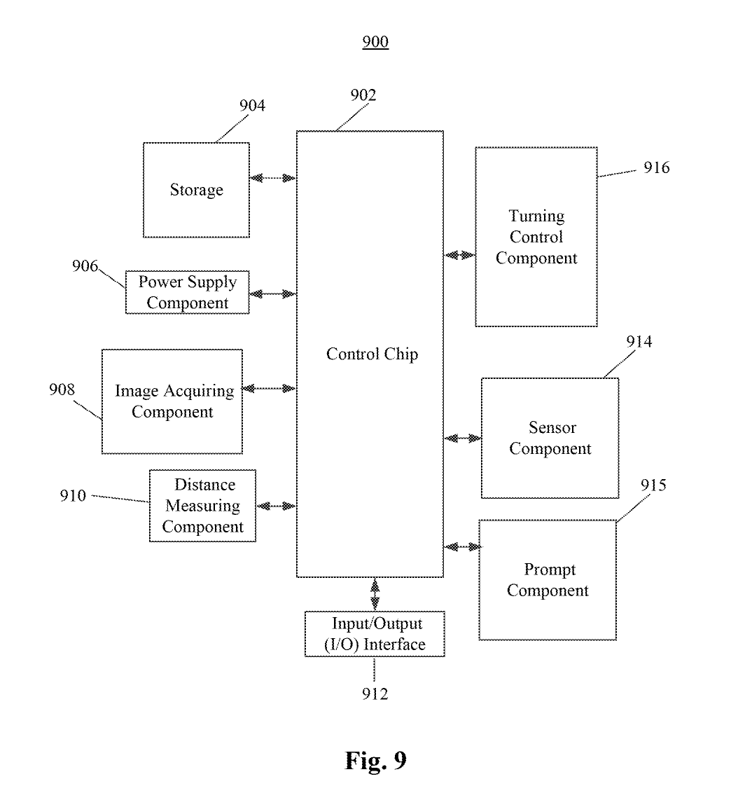

FIG. 9 is a block diagram of a balance car 900 according to an exemplary embodiment. Referring to FIG. 9, balance car 900 includes one or more of a control chip 902, a storage 904, a power supply component 906, an image acquiring component 908, a distance measuring component 910, an input/output (I/O) interface 912, a sensor component 914, a prompt component 915, and a turning control component 916.

Control chip 902 generally controls overall operations of balance car 900, such as operations related to moving forward, moving backward, acceleration, and deceleration. Control chip 902 also includes one or more modules to facilitate interaction between control chip 902 and other components. For example, control chip 902 includes an image acquiring module to facilitate interaction between image acquiring component 908 and control chip 902.

Storage 904 is configured to store various types of data so as to support operations of balance car 900. Examples of the data include any instructions, image data, and distance data used for operating balance car 900. Storage 904 can be any type of volatile or nonvolatile storage devices or their combinations, such as Static Random Access Memory (SRAM), Electrically Erasable Programmable Read Only Memory (EEPROM), Erasable Programmable Read Only Memory (EPROM), Programmable Read Only Memory (PROM), Read Only Memory (ROM), magnetic memory, flash memory, magnetic disk, or optical disc.

Power supply component 906 supplies electric power to various components of balance car 900. In an exemplary embodiment, power component 906 includes a power supply management system, one or more power supplies, and other components related to generation, management, and electric power distribution of balance car 900.

Image acquiring component 908 is included in the balance car 900. In an exemplary embodiment, image acquiring component 908 includes a front camera and/or a rear camera. When balance car 900 is in an operation mode, such as a capture mode or a video mode, the front camera and/or rear camera receive external multimedia data. Each of the front camera and the rear camera is a fixed optical lens system or a system having focus and optical zoom capability.

Distance measuring component 910 is configured to transmit and/or receive a detection signal. For example, distance measuring component 910 includes a laser transmitter. When balance car 900 is in an operation mode, such as when it receives a reflected laser, the laser transmitter is configured to receive a reflected signal of the detection signal. The received reflected signal is further stored in storage 904.

I/O interface 912 provides an interface between control chip 902 and the peripheral interface modules. The peripheral interface modules may be a USB flash disk, audio player, or the like. Sensor component 914 includes one or more sensors for providing status assessments of various aspects of balance car 900. For example, sensor component 914 detects an on/off state of balance car 900, and detects orientation or acceleration/deceleration changes of balance car 900. Sensor component 914 also includes an optical sensor, such as CMOS or CCD image sensor, to be used in imaging applications. In an exemplary embodiment, sensor component 914 includes an acceleration sensor, a gyroscope sensor, a magnetic sensor, a pressure sensor, or a temperature sensor, etc.

Turning control component 916 is configured to facilitate control of turning of the balance car 900. In an exemplary embodiment, turning control component 916 is a manually controlled turning control component, or a leg controlled turning control component.

In another exemplary embodiment, balance car 900 includes one or more of Application Specific Integrated Circuit (ASIC), Digital Signal Processor (DSP), Digital Signal Processing Device (DSPD), Programmable Logic Device (PLD), Field Programmable Gate Array (FPGA), controller, microcontroller, microprocessor, or other electronic elements for performing the above mentioned methods for controlling a balance car.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for controlling a balance car, comprising:
identifying an obstacle;
identifying a type of the obstacle in front of the balance car, the type of the obstacle including an impassable obstacle type; and
when the type of the obstacle is the impassable obstacle type, controlling the balance car to decelerate.

2. The method according to claim 1, wherein the type of the obstacle further comprises a passable obstacle type, and the method further comprises:
when the type of the obstacle is the passable obstacle type, increasing a driving force of the balance car to continue moving.

3. The method according to claim 1, wherein identifying the type of the obstacle in front of the balance car comprises:
measuring a height of the obstacle in front of the balance car by using a distance measuring component;
detecting whether the height of the obstacle is greater than a predetermined threshold; and
when the height of the obstacle is greater than the predetermined threshold, identifying the obstacle as the impassible obstacle type.

4. The method according to claim 2, wherein identifying the type of the obstacle in front of the balance car comprises:
measuring a height of the obstacle in front of the balance car by using a distance measuring component;
detecting whether the height of the obstacle is greater than a predetermined threshold; and
when the height of the obstacle is greater than the predetermined threshold, identifying the obstacle as the impassable obstacle type.

5. The method according to claim 1, wherein identifying the type of the obstacle in front of the balance car comprises:
acquiring an image frame in front of the balance car by using an image acquiring component;
identifying the obstacle in the image frame;
calculating a height of the obstacle;
detecting whether the height of the obstacle is greater than a predetermined threshold; and
when the height of the obstacle is greater than the predetermined threshold, identifying the obstacle as the impassable obstacle type.

6. The method according to claim 2, wherein identifying the type of the obstacle in front of the balance car comprises:
acquiring an image frame in front of the balance car by using an image acquiring component;
identifying the obstacle in the image frame;
calculating a height of the obstacle;
detecting whether the height of the obstacle is greater than a predetermined threshold; and
when the height of the obstacle is greater than the predetermined threshold, identifying the obstacle as the impassable obstacle type.

7. The method according to claim 1, the method further comprising:
measuring a distance between the obstacle and the balance car;
detecting whether the distance is less than a predetermined distance; and
when the distance is less than the predetermined distance, controlling the balance car to decelerate.

8. The method according to claim 1, the method further comprising:
when the type of the obstacle is the impassable obstacle type, providing a prompt indicating an existence of the obstacle in a predetermined mode, wherein the predetermined mode includes at least one of playing a prompt tone, vibrating a predetermine part of the balance car, and flickering a signal light.

9. The method according to claim 1, the method further comprising:
when the type of the obstacle is the impassable obstacle type, determining whether there is an alternate route in front of the balance car;
when there is the alternate route in front of the balance car, controlling the balance car to go along the alternate route; and
when there is no alternate route in front of the balance car, controlling the balance car to decelerate.

10. A balance car, comprising:
a control chip;
a storage for storing instructions executable by the control chip; wherein, the control chip is configured to:
identify an obstacle;
identify a type of the obstacle in front of the balance car, the type of the obstacle including an impassable obstacle type; and
when the type of the obstacle is the impassable obstacle type, control the balance car to decelerate.

11. The balance car according to claim 10, wherein the type of the obstacle further comprises a passable obstacle type; and the control chip is further configured to:
when the type of the obstacle is the passable obstacle type, increase a driving force of the balance car to continue moving.

12. The balance car according to claim 10, wherein the control chip is further configured to:
measure a height of the obstacle in front of the balance car by using a distance measuring component;
detect whether the height of the obstacle is greater than a predetermined threshold; and
when the height of the obstacle is greater than the predetermined threshold, identify the obstacle as the impassable obstacle type.

13. The balance car according to claim 11, wherein the control chip is further configured to:
measure a height of the obstacle in front of the balance car by using a distance measuring component;
detect whether the height of the obstacle is greater than a predetermined threshold; and
when the height of the obstacle is greater than the predetermined threshold, identify the obstacle as the impassable obstacle type.

14. The balance car according to claim 10, wherein the control chip is further configured to:
acquire an image frame in front of the balance car by using an image acquiring component;
identify the obstacle in the image frame;
calculate a height of the obstacle;
detect whether the height of the obstacle is greater than a predetermined threshold; and
when the height of the obstacle is greater than the predetermined threshold, identify the obstacle as the impassable object type.

15. The balance car according to claim 11, wherein the control chip is further configured to:
acquire an image frame in front of the balance car by using an image acquiring component;
identify the obstacle in the image frame;
calculate a height of the obstacle;
detect whether the height of the obstacle is greater than a predetermined threshold; and
when the height of the obstacle is greater than the predetermined threshold, identify the obstacle as the impassable object type.

16. The balance car according to claim 10, wherein the control chip is further configured to:
measure a distance between the obstacle and the balance car;
detect whether the distance is less than a predetermined distance; and
when the distance is less than the predetermined distance, control the balance car to decelerate.

17. The balance car according to claim 10, wherein the control chip is further configured to:
when the type of the obstacle is the impassable obstacle type, provide a prompt indicating an existence of the obstacle in a predetermined mode, wherein the predetermined mode includes at least one of playing a prompt tone, vibrating a predetermine part of the balance car, and flickering a signal light.

18. A non-transitory computer-readable storage medium having stored therein instructions that, when executed by a processor of a device, causes the device to perform a method for controlling a balance car, the method comprising:
identifying an obstacle;
identifying a type of the obstacle in front of the balance car, the type of the obstacle including an impassable obstacle type;
if the type of the obstacle is the impassable obstacle type, controlling the balance car to decelerate.

19. The non-transitory computer-readable storage medium of claim 18, the method further comprising:
when the type of the obstacle is a passable obstacle type, increasing a driving force of the balance car to continue moving.

20. The non-transitory computer-readable storage medium of claim 18, wherein identifying the type of the obstacle in front of the balance car comprises:
measuring a height of the obstacle in front of the balance car by using a distance measuring component;
detecting whether the height of the obstacle is greater than a predetermined threshold; and
when the height of the obstacle is greater than the predetermined threshold, identifying the obstacle as the impassible obstacle type.
